(19) United States
(12) Patent Application Publication
(10) Pub. No.: US 2010/0269979 A1
(43) Pub. Date: Oct. 28, 2010

(54) BLADDER PRESSURE BONDING APPARATUS

(75) Inventor: Paul Bryan Abitz, Tulsa, OK (US)

Correspondence Address: Hovey Williams LLP, 10801 Mastin Blvd., Suite 1000, Overland Park, KS, 66210, US

(73) Assignee: Spirit AeroSystems, Inc., Wichita, KS (US)

(21) Appl. No.: 12/749,575

(22) Filed: Mar. 30, 2010

Related U.S. Application Data
(60) Provisional application No. 61/172,972, filed on Apr. 27, 2009.

(51) Int. Cl. B32B 37/10

(52) U.S. Cl. 156/323; 156/60; 156/580

(57) ABSTRACT

An apparatus and method for providing pressure for bonding parts together. The apparatus may comprise a plurality of bladders independently actuatable to apply pressure for pushing a second part toward a first part having adhesive thereon. The apparatus may further comprise a frame supporting a plurality of reconfigurable bladder retainer devices positioned and angled such that the configuration of the bladders matches the contour of the second part. The bladders may expand and contract according to a sequence dictated by a control device, such that excess air and adhesive between the first and second part may be substantially squeegeed toward outer edges of the parts.

### RELATED APPLICATIONS

This non-provisional patent application claims priority benefit, with regard to all common subject matter, of earlier-filed U.S. Provisional Patent Application titled “Bladder Pressure Fixture Bond Assembly Jig”, Ser. No. 61/172,972, filed Apr. 27, 2009, hereby incorporated by reference in its entirety into the present application.

### BACKGROUND

1. Field

The present invention relates to an apparatus and method for bonding aircraft parts using a reconfigurable apparatus with independently expandable bladders to provide bonding pressure.

2. Related Art

When manufacturing aircraft parts, it is sometimes desired to bond thin aluminum sheets to carbon fiber or fiberglass leading edges of airplane slats, engine inlets, horizontal and vertical stabilizers, and aircraft wings. The aluminum sheet may be used to protect against rain erosion, hail, and small dents and to maintain standardized aesthetics during the life of the parts. However, due to different coefficients of thermal expansion of the parts' details, there is a risk of part deformation if heat is used in the bonding process.

Furthermore, the prior art method of vacuum bagging the parts and suctioning air out from within the vacuum bag to press the parts together can not be sufficiently controlled or selectively applied to specific areas of the parts. With the vacuum bagging method, bond details can also be forced together at random areas, sealing off the vacuum path and entrapping air. This can result in air entrapment in the final bonded part.

Accordingly, there is a need for an improved method and apparatus for bonding parts together.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Other aspects and advantages of the present invention will be apparent from the following detailed description of the embodiments and the accompanying drawing figures.

The present invention solves some of the above-described problems and provides a distinct advance in the art of bonding parts together. An apparatus for providing bonding pressure to bond a first part to a second part may comprise a frame, a plurality of malleable bladders held adjacent to each other by the frame, a bladder actuation device for actuating the bladders to expand and contract, and a control device to command the bladder actuation device to individually expand or contract any of the bladders. The bladders may each be independently actuated by the bladder actuation device, which may increase or decrease the amount of fluid, gas, or air within each of the bladders. The control device may command the bladder actuation device according to a predetermined or preprogrammed sequence of expansion or contraction of the bladders. For example, the control device may command the bladder actuation device to actuate expansion of one of the most centrally located bladders prior to actuating expansion of the most outwardly-located bladders.

A caul sheet may be placed between the bladders and the second part to more evenly distribute the pressure from the bladders to the second and first parts. The bladders may be attached to or partially retained within a plurality of retaining devices that are fixedly or reconfigurably attached to the frame. The retaining devices may be arranged and angled to cooperatively match a contour of the second part of which the bladders are configured to press against. The apparatus may also comprise a base tool on which the first part may rest, such that when the bladders expand, the second and first parts are pressed toward the base tool.

A method for bonding a second part to a first part may comprise the steps of placing the first part onto a base tool, placing adhesive onto the first part, placing the second part onto the adhesive and the first part, and then actuating one or more of a plurality of bladders to expand toward the second part, pressing the second part against the first part. Actuating the bladders may include independently actuating expansion or contraction of each of the bladders using a bladder actuation device operable to increase or decrease fluid, gas, or air pressure within the bladders. The method may also comprise arranging the bladders adjacent each other in a configuration that substantially matches contours of the first and/or second part. Finally, the method may comprise actuating each of the bladders at different points in time, for different lengths of time, and/or by different amounts of expansion or contraction using a control device. For example, the method may comprise commanding the bladder actuation device to actuate expansion of a centrally-located bladder prior to actuating expansion of a more outwardly-located bladder.

### BRIEF DESCRIPTION OF THE DRAWINGS

Embodiments of the present invention are described in detail below with reference to the attached drawing figures, wherein:

FIG. 1 is a perspective view of an apparatus for bonding parts together constructed according to an embodiment of the present invention;

FIG. 2 is a fragmentary perspective view of the apparatus of FIG. 1;

FIG. 3 is an exploded view of a base tool, a frame, and a plurality of bladders of the apparatus of FIG. 1 as well as layers of parts and materials sandwiched between the base tool and the bladders;

FIG. 4 is a fragmentary cross-sectional view of the layers of parts and materials sandwiched between the bladders and base tool of FIG. 3;

FIG. 5 is a flow chart of a method of bonding two parts according to an embodiment of the present invention; and

FIG. 6 is a cross-sectional elevation view of an alternative embodiment of the apparatus of FIG. 1 using a single bladder with a plurality of independently-inflatable compartments.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

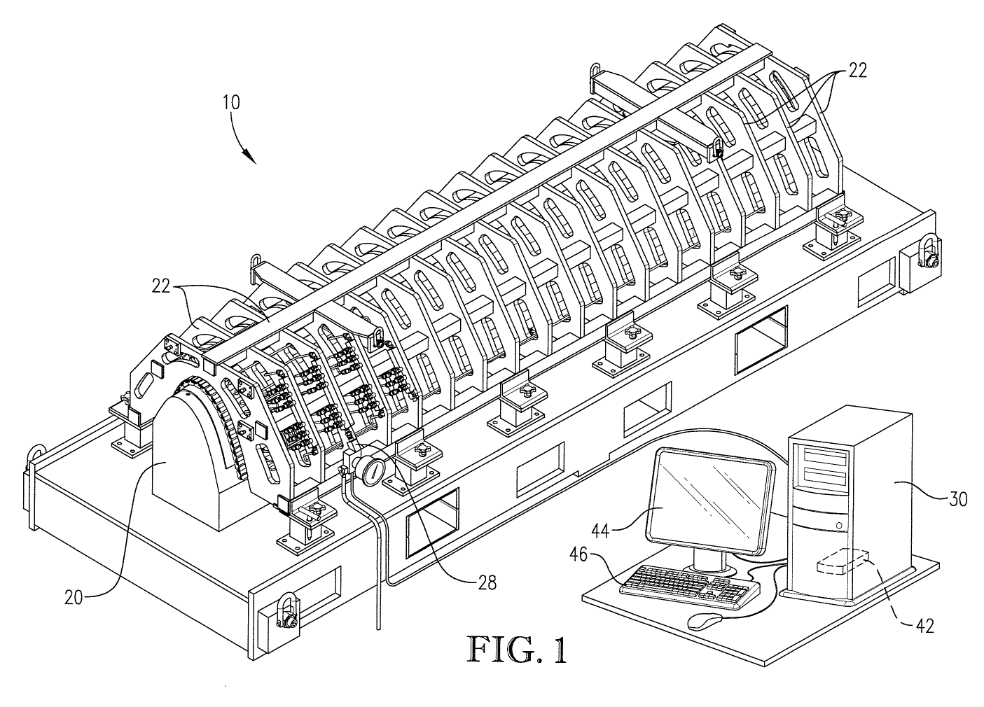

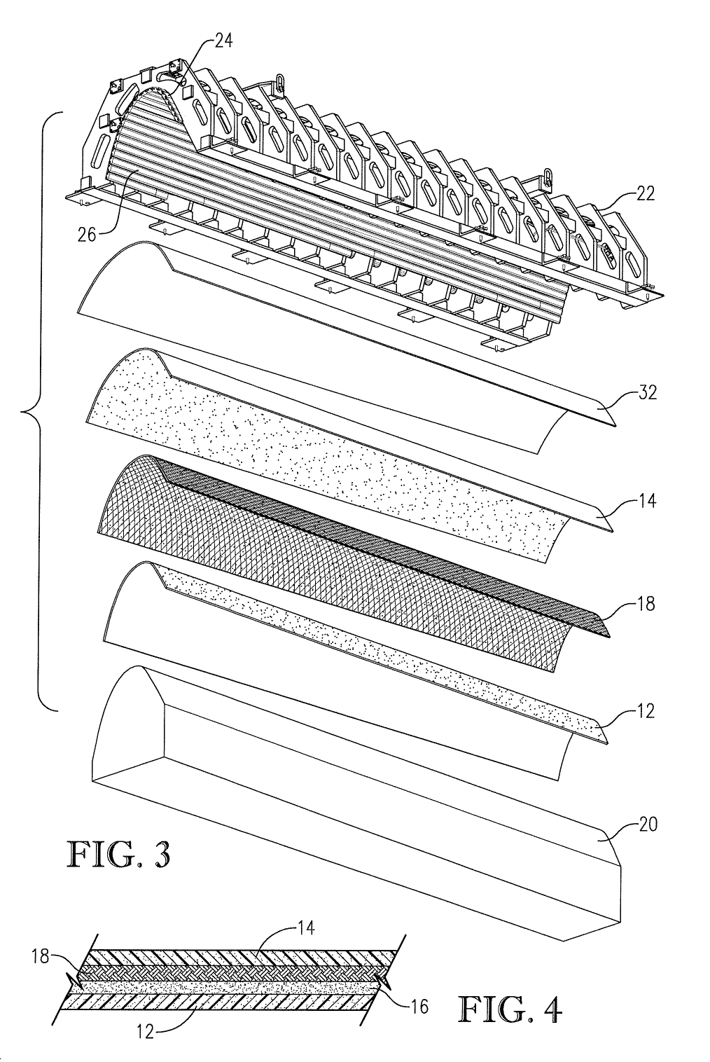

Embodiments of the present invention are illustrated in FIGS. 1-4 and include an apparatus 10 configured for providing bonding pressure to bond one or more parts together. For example, a first part 12 may be bonded to a second part 14, as illustrated in FIGS. 3 and 4. The first part 12 may be a sheet of material having a compound contoured surface. In one embodiment of the invention, the first part 12 may be a composite laminate skin or laminate part, such as those composed of carbon fiber reinforced plastic (CFRP) or glass fiber reinforced plastic (GFRP). The laminate part or skin may be an aircraft component such as an aircraft wing or leading edge panel. The second part 14 may be a sheet of material such as a thin aluminum sheet, a metallic sheet, or a composite sheet. The second part 14 may be sized and shaped such that at least a portion of the second part 14 may be bonded flush against at least a portion of the first part 12.

An adhesive 16 may be applied between the first part 12 and the second part 14 for bonding the two parts together, as illustrated in FIG. 4. The adhesive may be, for example, a two-part epoxy paste adhesive applied evenly to a large faying surface of the first part 12 with a grooved trowel. A porous sheet of material 18 may also be placed between the first and second parts 12, 14 to prevent the adhesive layer 16 from becoming too thin or from being squeezed completely out from between the first and second parts 12, 14 as bonding pressure is applied to the second part 14. For example, the porous sheet of material 18 may be a polyester scrim cloth. Additionally or alternatively, bead filler (not shown) such as fiberglass beads, microspheres, or micro balloons may be mixed into the adhesive to maintain a minimum bondline thickness of adhesive 16 between the first and second parts 12, 14.

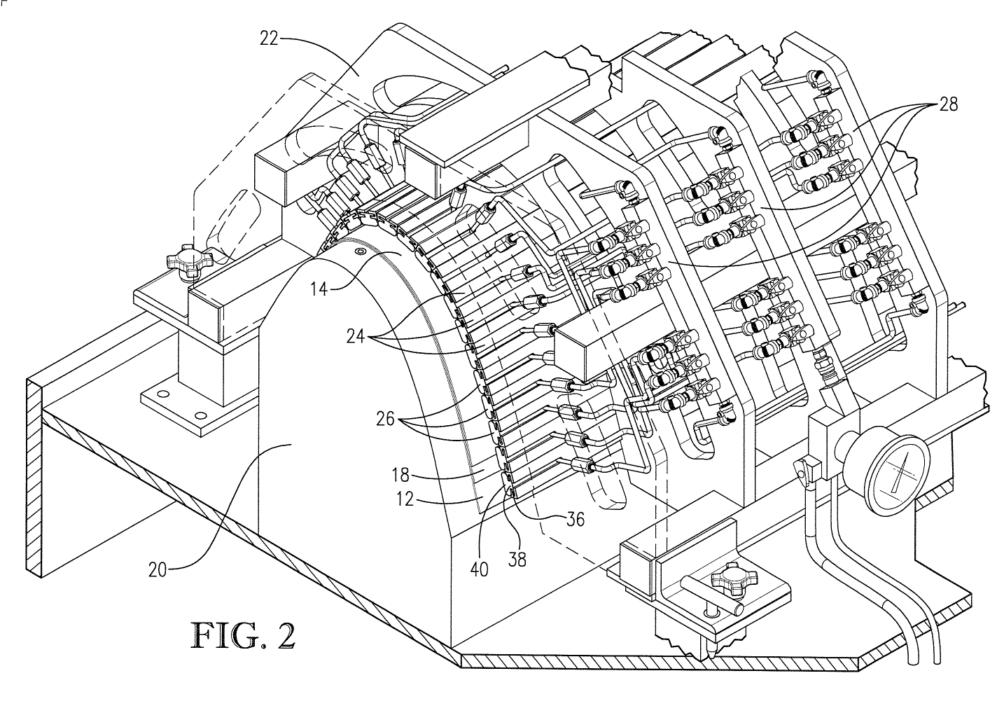

As illustrated in FIGS. 1 and 2, the apparatus 10 may comprise a tool base 20 for supporting the first part 12 thereon, a frame 22, a plurality of bladder retainer devices 24 attached to and supported by the frame 22, a plurality of bladders 26 supported by the bladder retainer devices 24 and positioned proximate to the tool base 20, and a bladder actuation device 28 configured for independently actuating each of the bladders 26 toward and away from the tool base 20 such that each of the bladders 26 may press the second part 14 toward the first part 12. Furthermore, the apparatus 10 may comprise a control device 30, as illustrated in FIG. 1, configured for instructing the bladder actuation device 28 as to when and by how much each of the bladders 26 should move toward or away from the tool base 20.

The tool base 20 may be any solid and/or rigid part and may have substantially the same shape as the first part 12 and configured to provide support for the first part 12 as the second part 14 is pressed against the first part 12. For example, the tool base 20 may be the shape of an edge of an aircraft wing, such that a skin of an aircraft wing may be supported thereon. In some embodiments of the invention, the tool base 20 may further comprise a vacuum and one or more vacuum inlets formed therein for suctioning the first part 12 against a surface of the tool base 20. The vacuum force may be used to maintain the first part 12 in place against the tool base 20 without using any mechanical fasteners.

The frame 22 may be of any size, shape, and configuration to hold the bladder retainer devices 24 and/or the bladders 26 a predetermined distance from the second part 14 and/or a caul sheet 32, which may be placed substantially adjacent to the bladders 26 and positioned between the bladders 26 and the base tool 20, as illustrated in FIG. 3. Specifically, the caul sheet 32 may be located between the bladders 26 and the second part 14, thereby providing a smooth surface to press the second part 14 toward the first part 12.

The frame 22 may support the bladder retainer devices 24 substantially above the tool base 20 and the first and second parts 12, 14. In some embodiments of the invention the bladder retainer devices 24 may be reconfigurable and/or extendable for selectively adjusting the location and/or angle of the retainer devices 24 and bladders 26, as later described herein. As illustrated in FIG. 1, the frame 22 may be comprised of a plurality of bolted and/or welded parts suspending the bladder retainer devices 24 in any desired configuration relative to the tool base 20. For example, the frame 22, may be placed over the tool base 20 after the first part 12, adhesive 16, porous sheet of material 18, second part 14, and/or caul sheet 32 are placed on the tool base 20, then the frame 22 may be bolted or otherwise fixedly secured to at least a portion of the tool base 20.

The plurality of bladder retainer devices 24, may be made of aluminum or any substantially durable substance and may be fixedly or reconfigurably attached to the frame 22 such that the retainer devices 24 may independently move the bladders 26 closer to or further away from the first and second parts 12, 14. Additionally or alternatively the retainer devices 24 may be reconfigurably attached to the frame 22 at a variety of adjustable angles. The angle and location of the retainer devices 24 may, in some embodiments of the invention, be determined by the angle and location of attachment parts (not shown) attaching the retainer devices 24 to the frame 22, while in other embodiments of the invention, the retainer devices 24 themselves are each individually adjustable relative to the frame 22. In other embodiments of the invention, material may be removed from the retainer devices 24 to create a proper amount of clearance and then the retainer devices 24 may be formed and bolted to aluminum headers (not shown) or other attachment components of the frame 22 which follow the contour of the first and/or second part 12, 14.

The plurality of bladders 26 may each comprise any apparatus operable to move closer to and further away from the tool base 20 and/or the second part 14. For example, the bladders 26 may each be substantially hollow and formed of rubber or any other substantially expandable or stretchable material. For example, the bladders 26 may be configured for expanding and contracting toward and away from the second part 14. The hollow space within the bladders 26 may each be fillable with a substance such as liquid, gas, or air, thereby causing the bladders 26 to expand as they are filled with the substance. In some embodiments of the invention, the bladders 26 may each comprise a first portion 36 retained within the corresponding retainer device 24, a second portion 38 narrower than the first portion 36 and extending out from within the retainer device 24, a third portion 40 outward of the retainer device 24 and configured to expand and apply pressure to the second part 14 for bonding the first and second parts 12, 14 together.

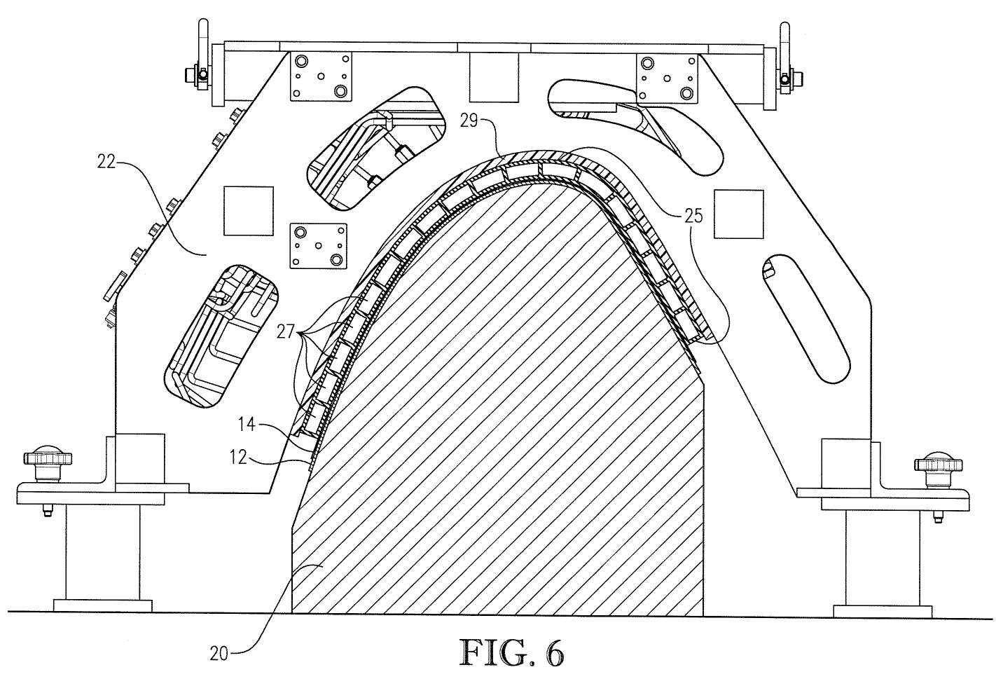

FIG. 6 illustrates an alternative embodiment of the invention in which the plurality of bladders 26 are replaced with a single bladder 25 having a plurality of individually inflatable compartments 27. In this embodiment of the invention, each compartment 27 of the single bladder 25 may be in fluid communication with the bladder actuation device 28, such that each compartment 27 may be expanded or contracted independently. The bladder 25 may be supported by a facesheet 29, which may be an aluminum sheet or a fiberglass laminate approximately 0.25 inches to 0.5 inches thick. A profile of the facesheet 29 may be machined to a desired contour and may comprise openings formed therethrough for connection of the bladder actuation device 28 to the compartments 27.

The bladder actuation device 28 may be any apparatus operable to individually and independently actuate at least a portion of each of the bladders 25 or 26 toward and/or away from the tool base 20 and/or the second part 14. In some embodiments of the invention, the bladder actuation device 28 may actuate expansion and/or contraction of each of the bladders 26 or bladder compartments 27 of the bladder 25. The bladder actuation device 28 may comprise a manifold, as illustrated in FIG. 2, which may comprise a plurality of tubes and corresponding valves in communication with each of the bladders 26 or bladder compartments 27 of the bladder 25 for supplying various amounts of fluid, gas, or air into the bladders 26 or compartments 27. For example, the manifold may be configured to selectively provide air, such as regulated shop air, to each of the bladders 26 or compartments 27 independently. Opening and closing of the valves may be electrically or manually actuated. Expanding and contracting the bladders 26 or compartments 27 may comprise increasing or decreasing an amount of any substance within the bladders 26 or compartments 27.

The control device 30, as illustrated in FIG. 1, may be configured for actuating the bladders 26 or compartments 27 individually according to a predetermined sequence, increasing and/or decreasing the amount of liquid, gas, and/or air within the bladders 26 or compartments 27. The control device 30 may comprise any number and combination of processors, controllers, integrated circuits, programmable logic devices, or other data and signal processing devices for carrying out the functions described herein, and may additionally comprise one or more memory storage devices, transmitters, receivers, and/or communication busses for communicating with the various components of the apparatus 10. In various embodiments of the invention, the control device 30 may also comprise a memory element 42, a display 44, and/or a user interface 46.

In some embodiments of the invention, the control device 30 may implement a computer program and/or code segments to perform some of the functions described herein. The computer program may comprise a listing of executable instructions for implementing logical functions in the control device 30. The computer program can be embodied in any computer readable medium for use by or in connection with an instruction execution system, apparatus, or device that can execute the instructions. In the context of this application, a “computer readable medium” can be any means that can contain, store, communicate, propagate, or transport the program for use by or in connection with the instruction execution system, apparatus, or device. The computer readable medium can be, for example, but not limited to, an electronic, magnetic, optical, electro magnetic, infrared, or semi conductor system, apparatus, device or propagation medium. More specific, although not inclusive, examples of the computer readable medium would include the following: a portable computer diskette, a random access memory (RAM), a read only memory (ROM), an erasable, programmable, read only memory (EPROM or flash memory), and a portable compact disk read only memory (CDROM), combinations thereof, and the like.

The memory element 42 may be integral with the control device 30, stand alone memory, or a combination of both. The memory element 42 may include, for example, removable and non removable memory elements such as RAM, ROM, flash, magnetic, optical, USB memory devices, and/or other memory elements. The memory element 42 may store instructions regarding when to apply pressure via the bladders 26 or compartments 27, an order in which to apply pressure via the bladders 26 or compartments 27, an amount of pressure to be provided via the bladders 26 or compartments, and/or other data for instructing the control device 30 to perform the functions and methods described herein.

The display 44 may comprise a graphical interface operable to display visual graphics, images, text, etc. in response to external or internal processes and commands. For example, the display 44 may comprise conventional black and white, monochrome, or color display elements including CRT, TFT, LCD, and/or LED display devices. The display 44 may be integrated with the user interface 46, such as in embodiments where the display is a touch screen display to enable the user to interact with it by touching or pointing at display areas to provide information to the control device 30. The display 44 may be coupled with various other components of the control device 30 and may be operable to display various information corresponding to the apparatus 10.

The user interface 46 may enable one or more users to share information and commands with the apparatus 10, such as defining the contours and/or shape of the first and second parts 12, 14, instructing the bladder retainer devices 24 to move to a particular position or angle according to the shapes and contours of the first and second parts 12, 14, providing an actuation sequence for the bladders 26 or compartments 27, providing an amount of gas, air, or liquid to apply to each of the bladders 26 or compartments 27, or any other information for starting, stopping, or programming the control device 30. The user interface 46 may comprise one or more functionable inputs such as buttons, switches, scroll wheels, a touch screen associated with the display, voice recognition elements such as a microphone, pointing devices such as mice, touchpads, tracking balls, styluses, a camera such as a digital or film still or video camera, combinations thereof, etc. Further, the user interface 46 may comprise wired or wireless data transfer elements such as a removable memory, data transceivers, a transmitter, and the like, to enable the user and other devices or parties to remotely interface with the apparatus 10. The user interface 46 may also include a speaker for providing audible instructions and feedback.

In use, the apparatus 10 may be used for bonding the second part 14 to the first part 12 by placing the adhesive 16 onto the first part 12, placing the second part onto the adhesive and the first part, then actuating at least one of the bladders 26 or compartments 27 to expand toward the second part 14, thereby pressing the second part 14 toward the first part 12. For example, each of the bladders 26 or compartments 27 may be individually actuated by varying amounts of pressure applied at different times for desired lengths of time as the adhesive bonds the two parts 12, 14 together.

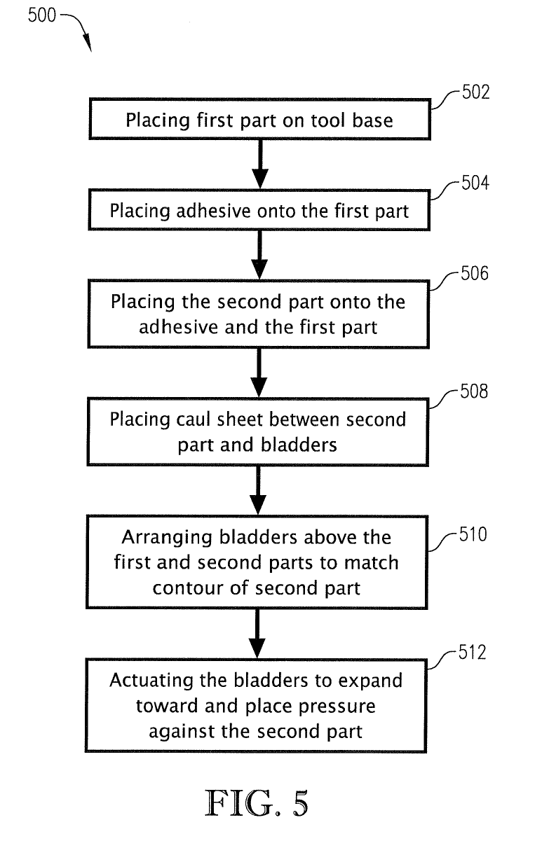

The flow chart of FIG. 5 depicts the steps of exemplary methods of the invention in more detail. In some alternative implementations, the functions noted in the various blocks may occur out of the order depicted in FIG. 5. For example, two blocks shown in succession in FIG. 5 may in fact be executed substantially concurrently, or the blocks may sometimes be executed in the reverse order depending upon the functionality involved.

FIG. 5 illustrates a method 500 of bonding the first and second parts 12, 14 together. As depicted in step 502, the method 500 may comprise placing the first part 12 on the base tool 20 configured for supporting the first part 12 between the second part 14 and the tool base 20. Then the adhesive 16 may be applied to the first part 12, as depicted in step 504, and the second part 14 may be placed onto the adhesive 16, as depicted in step 506. As explained above, a porous sheet of material 18 and/or bead filler and the like may also be applied between the first and second parts 12, 14 to provide a minimum thickness of the bondline formed between the two parts 12, 14.

The caul sheet 32 may be placed between at least one of the bladders 25 or 26 and the second part 14, as depicted in step 508. The caul sheet 32 can be used to help even out the distribution of pressure provided by the individual bladders 26 or compartments 27 to the parts 12, 14. Additionally, the method 500 may comprise arranging the plurality of bladders 26 substantially adjacent with each other in a configuration that substantially matches contours of the first and/or second parts 12, 14, as depicted in step 510. For example, a user and/or the control device 30 may manually or automatically angle or relocate one or more of the retainer devices 24 and/or attachment parts 34 to achieve a desired distance and relative angle of the bladders 26 to the second part 14.

The method 500 may also comprise actuating at least one of the bladders 26 or compartments 27 to expand toward the second part 14, thereby pressing the second part 14 toward the first part 12, as depicted in step 512. This actuation step may comprise independently actuating expansion or contraction of each of the bladders 26 using the bladder actuation device 28 operable to increase or decrease fluid, gas, or air pressure within each of the bladders independently. Alternatively, in the embodiment illustrated in FIG. 6, the method may comprise independently actuating expansion or contraction of one or more of the compartments 27 of the bladder 25 to expand toward the second part 14.

Furthermore, the actuation step may comprise controlling at least one of when and by how much each of the bladders 26 or the compartments 27 expand or contract using the control device 30. For example, one or more of the bladders 26 most centrally located relative to the others of the bladders 26 may be actuated into the second part 14 first, followed by successive adjacent bladders, with the outward most bladders 26 having pressure applied thereto last. Using this sequence, the plurality of bladders 26 squeegee out any air and excess adhesive in an outward direction. In another example embodiment of the invention, the bladders 26 may be actuated in a sequence starting at a first end and finishing at a second end, such that all excess adhesive and air is squeegeed toward the second end. The application of pressure by each of the bladders 26 may be timed to allow the adhesive 16 to flow outward where no pressure is present prior to applying pressure with an adjacent one of the bladders 26. The actuation step may also comprise controlling an expansion speed of each of the bladders 26.

In alternative embodiments of the invention, such as the embodiment illustrated in FIG. 6, one or more of the compartments 27 most centrally located relative to the other compartments 27 may be actuated into the second part 14 first, followed by successive adjacent compartments 27, with the outward most compartments 27 having pressure applied thereto last. In other alternative embodiments of the invention, the compartments 27 may be actuated in a sequence starting at a first end and finishing at a second end, such that all excess adhesive and air is squeegeed toward the second end.

The method described above may be used for bonding parts requiring faying surface bonds, particularly parts with severely contoured moldline surface shapes. Furthermore, the method may be used for room temperature cure or bonding of parts having dissimilar coefficients of thermal expansion. Alternatively, the method described above may also be used for parts having similar materials with similar coefficients of thermal expansion bonded and/or cured at elevated temperatures.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. An apparatus for providing bonding pressure to bond parts together, the apparatus comprising:
a frame;
a plurality of malleable bladders held adjacent to each other by the frame and configured for independently expanding and contracting;
a bladder actuation device configured for actuating the bladders to expand and contract; and
a control device communicably coupled with the bladder actuation device and configured to control the bladder actuation device.

2. The apparatus of claim 1, wherein the control device is further configured to command at least one of when and by how much the bladder actuation device individually expands or contracts the bladders.

3. The apparatus of claim 1, further comprising:
a plurality of retaining devices, each fixedly attached to one of the bladders and reconfigurably attached to the frame.

4. The apparatus of claim 1, further comprising a base tool positioned proximate to the bladders and configured for supporting at least one of the parts between the bladders and the base tool.

5. The apparatus of claim 4, further comprising a caul sheet adjacent to the bladders and positioned between the bladders and the base tool.

6. The apparatus of claim 1, wherein the bladder actuation device is configured to increase or decrease the amount of fluid, gas, or air within each of the rubber bladders.

7. The apparatus of claim 1, wherein the bladders are made of rubber.

8. The apparatus of claim 1, wherein the control device is further configured to command the bladder actuation device to actuate the bladders according to a predetermined sequence of expansion or contraction of the bladders.

9. The apparatus of claim 1, wherein the control device is configured to command the bladder actuation device to actuate expansion of at least one of the bladders most centrally located prior to actuating expansion of at least one of the bladders most outwardly located.

10. A method for bonding a second part to a first part, the method comprising:
placing adhesive onto the first part;
placing second part onto the adhesive and the first part; and
actuating at least one bladder to expand toward the second part, thereby pressing the second part toward the first part.

11. The method of claim 10, further comprising placing the first part on a base tool configured for supporting the first part between the second part and the tool base.

12. The method of claim 10, wherein the at least one bladder comprises a plurality of bladders or a single bladder with a plurality of compartments.

13. The method of claim 12, further comprising the step of:
independently actuating expansion or contraction of each of the bladders or compartments using a bladder actuation device operable to increase or decrease fluid, gas, or air pressure within each of the bladders or compartments independently.

14. The method of claim 12, further comprising arranging the plurality of bladders substantially adjacent with each other in a configuration that substantially matches contours of the first or second part.

15. The method of claim 10, further comprising the step of placing a caul sheet between the at least one bladder and the second part.

16. The method of claim 12, further comprising the step of controlling at least one of when and by how much each of the bladders or compartments expands or contracts using a control device.

17. The method of claim 13, further comprising commanding the bladder actuation device to actuate expansion of at least one of the bladders or compartments most centrally located prior to actuating expansion of at least one of the bladders or compartments most outwardly located.

18. A method for bonding a second part to a first part, the method comprising:
placing adhesive onto the first part;
placing the second part onto the adhesive and the first part;
arranging a plurality of bladders substantially adjacent with each other in a configuration that substantially matches contours of the first or second part, wherein the second part is positioned between the first part and the bladders; and
independently actuating each of the bladders to expand toward the second part according to a pre-determined sequence, thereby pressing the second part toward the first part.

19. The method of claim 18, further comprising the step of controlling at least one of when and by how much each of the bladders expands or contracts using a control device.

20. The method of claim 18, further comprising commanding the bladder actuation device to actuate expansion of at least one of the bladders most centrally located prior to actuating expansion of at least one of the bladders most outwardly located.
